(19) United States
(12) Patent Application Publication
(10) Pub. No.: US 2024/0076442 A1
(43) Pub. Date: Mar. 7, 2024

(54) BIOBASED POLYESTERS WITH ENHANCED PROPERTIES

(71) Applicant: Braskem S.A., Camaçari (BR)

(72) Inventors: Nei Sebastião Domingues Junior, São Paulo City (BR); Marcela Mantese Sander, São Paulo City (BR); Adriane Gomes Simanke, São Paulo (BR)

(73) Assignee: Braskem S.A., Camaçari (BR)

(21) Appl. No.: 18/454,423

(22) Filed: Aug. 23, 2023

Related U.S. Application Data
(60) Provisional application No. 63/400,292, filed on Aug. 23, 2022.

(51) Int. Cl. C08G 63/06; C08G 63/85; C08J 9/00

(52) U.S. Cl. CPC C08G 63/06; C08G 63/85; C08J 9/0095

(57) ABSTRACT

A polyester composition includes 10 to 90 wt % of recurring units derived from a long-chain aliphatic diacid or diol, 10 to 90 wt % of recurring units derived from a short-chain aliphatic diacid or diol, and to 50 wt % of recurring units derived from a functionalized comonomer having two terminal acid, ester, or alcohol groups.

### BACKGROUND

Producing polymers from totally renewable raw materials with enhanced properties that are able to be easily recycled is a challenge. It is possible to produce polyesters from renewable long-chain aliphatic monomers, which have a crystalline structure and mechanical properties similar to polyethylene. However, other properties, such as barrier properties and adhesion may still be improved in polyesters prepared from renewable resources.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polyester composition including 10 to 90 wt % of recurring units derived from a long-chain aliphatic diacid or diol, 10 to 90 wt % of recurring units derived from a short-chain aliphatic diacid or diol, and to 50 wt % of recurring units derived from a functionalized comonomer having two terminal acid, ester, or alcohol groups.

In another aspect, embodiments disclosed herein relate to a method of producing a polyester including 10 to 90 wt % of recurring units derived from a long-chain aliphatic diacid or diol, 10 to 90 wt % of recurring units derived from a short-chain aliphatic diacid or diol, and to 50 wt % of recurring units derived from a functionalized comonomer having two terminal acid, ester, or alcohol groups, the method including polymerizing the long-chain aliphatic diacid or diol, the short-chain aliphatic diacid or diol, and the functionalized co-monomer by melt polycondensation.

In yet another aspect, embodiments disclosed herein relate to an article that includes a biobased polyester including 10 to 90 wt/o of recurring units derived from a long-chain aliphatic diacid or diol, 10 to 90 wt/o of recurring units derived from a short-chain aliphatic diacid or diol, and to 50 wt % of recurring units derived from a functionalized comonomer having two terminal acid, ester, or alcohol groups.

In yet another aspect, embodiments disclosed herein relate to a blended polymer composition including a first polymer; and a second polymer, wherein at least one of the first polymer and the second polymer includes 10 to 90 wt % of recurring units derived from a long-chain aliphatic diacid or diol, 10 to 90 wt % of recurring units derived from a short-chain aliphatic diacid or diol, and to 50 wt % of recurring units derived from a functionalized comonomer having two terminal acid, ester, or alcohol groups.

In yet another aspect, embodiments disclosed herein relate to a method of producing a blended polymer that includes a first polymer; and a second polymer, wherein at least one of the first polymer and the second polymer includes 10 to 90 wt % of recurring units derived from a long-chain aliphatic diacid or diol, 10 to 90 wt/o of recurring units derived from a short-chain aliphatic diacid or diol, and to 50 wt % of recurring units derived from a functionalized comonomer having two terminal acid, ester, or alcohol groups, wherein the method includes combining the first polymer and the second polymer to form a mixture; and extruding the mixture to form the blended polymer.

Other aspects and advantages of the claimed subject matter will be apparent from the following description and the appended claims.

### DETAILED DESCRIPTION

The present disclosure generally relates to a polyester composition, blends thereof, and methods of preparation thereof. In one or more embodiments, polyester compositions are prepared from the reaction between a long-chain aliphatic diacid or diol, a short-chain aliphatic diacid or diol, and a functionalized comonomer having two terminal acid, ester, or alcohol groups. Polyester compositions disclosed herein may have enhanced barrier properties and adhesion, as well as comparable mechanical and thermal properties as compared to polyethylene.

In one or more embodiments, each of the long-chain aliphatic diacid or diol, the short-chain aliphatic diacid or diol, and the functionalized comonomer may be prepared from renewable resources. Herein, monomers that are made from renewable resources may be referred to as “biobased” monomers and are distinguished from polymers and monomers obtained from fossil-fuel sources. A polyester composition prepared from one or more biobased monomers may be a biobased polyester. Because biobased materials are obtained from sources that may actively reduce CO2 in the atmosphere or otherwise require less CO2 emission during production, such materials are often regarded as “green” or renewable. However, it is also envisioned that the compositions may be exclusively biobased polyester or alternatively, may include a blend of biobased polyester and petroleum-based polyester without deviating from the scope of the present disclosure. In one or more embodiments, the low density polyethylene may have a biobased carbon content as determined by ASTM D6866-18 Method B at a percent in a range having a lower limit selected from any 50%, 60%, 70%, 80%, 90%, and 100%.

Polyester Composition

In one aspect, embodiments disclosed herein relate to a polyester composition. As described above, the polyester composition may have recurring units derived from a long-chain aliphatic diacid or diol, a short-chain aliphatic diacid or diol, and a functionalized comonomer having two terminal acid, ester, or alcohol groups.

In one or more embodiments, polyester compositions include recurring units derived from a long-chain aliphatic diacid or diol. The long-chain aliphatic diacid or diol may be a saturated or unsaturated aliphatic diacid or diol having a hydrocarbon chain that includes from 14 to 18 carbon atoms. Exemplary long-chain aliphatic diacids and diols include, but are not limited to, 1,18-octadecanedioic acid, 1,16-hexadecanoic acid, 1,14-tetradecanedioic acid, 1,18-octadecanediol, 1,16-hexadecanediol, 10,11-dioctylicosanedioic acid, and dimer linoleic diol. In one or more embodiments, the long-chain aliphatic diacid or diol is a biobased aliphatic diacid or diol.

Polyester compositions may include recurring units from a long-chain aliphatic diacid or diol in an amount ranging from 10 to 90 wt % (weight percent), based on the total weight of the polyester. For example, in one or more embodiments, polyester compositions may include recurring units from a long-chain aliphatic diacid or diol in an amount ranging from a lower limit of one of 10, 20, 30, 40, and 50 wt % to an upper limit of one of 70, 75, 80, 85, 90 wt %, where any lower limit may be paired with any mathematically compatible upper limit. While in one or more embodiments, polyester may be reacted from the long-chain aliphatic diacid or diol, in one or more other embodiments, the polyester compositions may be derived from or include recurring units from a long-chain aliphatic diester that were derived from a long-chain diacid. It is envisioned that the polyester may include recurring units from a long-chain aliphatic diester formed from the esterification of the long-chain aliphatic diacid. Thus, the long-chain aliphatic diacid may be converted to its corresponding diester using conventional esterification reactions that take place prior to forming the polyester. Moreover, it is envisioned that the alcohol used in the esterification may include, for example, methanol or ethanol or other short-chain alcohols.

In one or more embodiments, polyester compositions include recurring units derived from a short-chain aliphatic diacid or diol. The short-chain aliphatic diacid or diol may be a saturated or unsaturated aliphatic diacid or diol having a hydrocarbon chain including less than 14 carbon atoms. Suitable short-chain aliphatic diacids and diols include, but are not limited to, succinic acid, malonic acid, adipic acid, pimelic acid, suberic acid, oxalic acid, itaconic acid, undecanedioic acid, nonanedioic acid, 1,3-propanediol, 1,4-butanediol, 1,5-pentanediol, and 1,6-hexanediol. In some embodiments, the short-chain aliphatic diacid or diol is a biobased aliphatic diacid or diol.

Polyester compositions may include recurring units of a short chain aliphatic diacid or diol in an amount ranging from 10 to 90 wt %, based on the total weight of the polyester. For example, in one or more embodiments, polyester compositions may include recurring units from a short-chain aliphatic diacid or diol in an amount ranging from a lower limit of one of 10, 20, 30, 40, and 50 wt % to an upper limit of one of 70, 75, 80, 85, 90 wt %, where any lower limit may be paired with any mathematically compatible upper limit.

In one or more embodiments, polyester compositions include a functionalized comonomer. The functionalized comonomer may include two terminal acid, ester, or alcohol groups. In one or more embodiments, the functionalized comonomer may have a “functional group” between the two terminal acid, ester, or alcohol groups, which may include aromaticity, heterocyclic groups, branching, unsaturated chains or vinyl groups, hydroxy groups, and the like. Suitable functionalized comonomers are aromatic diacids, aromatic diesters, hydroxyacids, heterocyclic diols, unsaturated aliphatic diacids, unsaturated aliphatic diols, and combinations thereof. For example, functionalized comonomers that may be included in polyester compositions of the present disclosure include, but are not limited to, 2,5-furandicarboxylic acid, 2,4-furandicarboxylic acid, methyl furan-2,5-dicarboxylate, methyl furan-2,4-dicarboxylate, 3-hydroxypropionic acid, glycolic acid, muconic acid, methyl vinyl glycolate, isosorbide, isoidide, isomannide, oxalic acid, and itaconic acid. In some embodiments, the functionalized comonomer is a biobased functionalized comonomer.

Polyester compositions may include recurring units of a functionalized comonomer in an amount ranging from 0.1 to 50 wt %, based on the total weight of the polyester. For example, in one or more embodiments, recurring units derived from a functionalized comonomer may be included in a polyester composition in an amount ranging from a lower limit of one of 0.1, 0.2, 0.5, 1.0, 2.5, 5.0, and 7.5 wt % to an upper limit of one of 10, 20, 30, 35, 40, 45, and 50 wt %, where any lower limit may be paired with any mathematically compatible upper limit. In particular embodiments, the polyester composition includes recurring units derived from a functionalized monomer in an amount ranging from 0.1 to 10 wt %, based on the total weight of the polyester.

In one or more embodiments, the polyester composition may be a semi-crystalline polymer. Semi-crystalline polymers may include crystalline regions within an amorphous matrix. Such polymers may exhibit increased mechanical properties while maintaining good flexibility. Semi-crystalline polyester compositions disclosed herein may have a crystallinity, measured according to ASTM D3418, of up to 70%. Such polyester compositions may include a higher concentration of recurring units derived from a long-chain aliphatic diacid or diol. Alternatively, in one or more embodiments, the polyester composition is an amorphous polymer. Polyester compositions that include a higher concentration of recurring units derived from a functionalized comonomer may be amorphous.

Polyester compositions in accordance with the present disclosure may have a number average molecular weight (Mn) ranging 500 to 1,000,000 g/mol. For example, in one or more embodiments, polyester compositions have an Mn ranging from a lower limit of one of 500, 1,000, 2,500, 5,000, 10,000, 20,000, 50,000 and 100,000 g/mol to an upper limit of one of 500,000, 600,000, 700,000, 800,000, 900,000, and 1,000,000 g/mol where any lower limit may be paired with any mathematically compatible upper limit. Polyester compositions having a Mn ranging from 500 to 1,000,000 g/mol may have similar mechanical and thermal properties to polyethylene.

Mn values may be obtained by gel permeation chromatography (GPC) according to ISO 16014-4:2003 and ASTM D 6474-99. High temperature GPC analyses may be performed using a Viscotek system (from Malvern Instruments) equipped with three columns (PLgel Olexis 300 mm-7 mm I.D. from Agilent Technologies). 200 μL of sample solutions with a concentration of 5 mg mL-1 were eluted in 1,2,4-trichlorobenzene using a flow rate of 1 mL min-1 at 150° C. The mobile phase may be stabilized with 2,6-di-tert-butyl-4-methylphenol (butylated hydroxytoluene, BHT, 200 mg L-1). Online detection may be performed with a differential refractive index detector and a dual light scattering detector (LALS and RALS) for absolute molar mass measurement. The OmniSEC 5.02 software may be used for calculations.

In one or more embodiments, polyester compositions have a melt temperature ranging from 60 to 150° C., as measured by ASTM D3418. For example, polyester compositions may have a melt temperature ranging from a lower limit of one of 60, 65, 70, 75, 80, 85, and 90° C. to an upper limit of one of 100, 110, 120, 130, 140, and 150° C., where any lower limit may be paired with any mathematically compatible upper limit. In particular embodiments, the polyester composition has a melt temperature ranging from 80 to 120° C., as measured by ASTM D3418.

As described above, polyester compositions in accordance with the present disclosure may have mechanical properties comparable to polyethylene. Such properties may include tensile modulus, tensile elongation at break, and tensile strength at break. Tensile tests to determine these properties may be carried out according to methods known in the art, such as, for example, according to ASTM D638 Specimen Type IV.

In one or more embodiments, the polyester composition has a tensile modulus, at a 1% secant, ranging from 120 to 800 MPa, as measured according to ASTM D638 Specimen Type IV. For example, polyester compositions in accordance with the present disclosure may have a tensile modulus ranging from a lower limit of one of 120, 140, 180, 200, 250, and 300 MPa to an upper limit of one of 400, 500, 600, 700, and 800 MPa, where any lower limit may be paired with any mathematically compatible upper limit.

In one or more embodiments, the polyester composition has a tensile elongation at break ranging from 100 to 1500%, as measured according to ASTM D638 Specimen Type IV. For example, polyester composition in accordance with the present disclosure may have a tensile elongation at break ranging from a lower limit of one of 100, 200, 300, 400, and 500% to an upper limit of one of 1000, 1100, 1200, 1300, 1400, and 1500%, where any lower limit may be paired with any mathematically compatible upper limit.

In one or more embodiments, the polyester composition has a tensile strength at break ranging from 15-100 MPa, as measured according to ASTM D638 Specimen Type IV. For example, polyester composition in accordance with the present disclosure may have a tensile strength at break ranging from a lower limit of one of 15, 20, 25, 30, 35, 40, and 45 MPa to an upper limit of one of 70, 75, 80, 85, 90, 95, and 100 MPa, where any lower limit may be paired with any mathematically compatible upper limit.

As described above, polyester compositions in accordance with the present disclosure exhibit increase adhesion compared to polyethylene, as measured according to ASTM F88.

In one or more embodiments, polyester compositions may be included in articles. Suitable articles that may include a polyester composition disclosed herein include films, fibers, filaments, blow-molded articles, 3D printed articles, and injection-molded articles. Such articles may be prepared using polyester compositions of one or more embodiments according to methods known in the art.

As described above, articles prepared from polyester compositions in accordance with the present disclosure may exhibit improved barrier properties compared to articles prepared from conventional polyethylene. As will be appreciated by one of ordinary skill in the art, the permeability of a polymer may be the inverse of its barrier properties. For example, a polymer with low permeability is considered to have high barrier properties. Thus, the permeation, or transmission, of gases through a polymer membrane may provide insight into the barrier properties of that polymer. The transmission of gases through a polymer membrane may be measured according to standard methods, such as, for example, according to ASTM F1927.

In one or more embodiments, articles prepared from polyester compositions herein have an oxygen (O₂) transmission rate ranging from 0.01 to 100 cc·mil/in²·day·atm, measured according to ASTM F1927. For example, films or blow-molded articles prepared from the polyester composition of one or more embodiments may have an 02 transmission rate ranging from a lower limit of one of 0.01, 0.05, 0.1, 0.2, 0.5, and 1.0 cc·mil/in²·day·atm to an upper limit of one of 50, 60, 70, 80, 90, and 100 cc·mil/in²·day·atm, where any lower limit may be paired with any mathematically compatible upper limit.

In one or more embodiments, articles prepared from polyester compositions herein have a carbon dioxide (CO₂) transmission rate ranging from 0.01 to 100 cc·mil/in²·day·atm, measured according to ASTM F2476. For example, films or blow-molded articles prepared from the polyester composition of one or more embodiments may have a CO₂ transmission rate ranging from a lower limit of one of 0.01, 0.05, 0.1, 0.2, 0.5, and 1.0 cc·mil/in²·day·atm to an upper limit of one of 50, 60, 70, 80, 90, and 100 cc·mil/in²·day·atm, where any lower limit may be paired with any mathematically compatible upper limit.

Methods of Preparing Polyester Compositions

In another aspect, embodiments of the present disclosure relate to a method of preparing the polyester compositions previously described. Methods may include polymerizing a long-chain aliphatic diacid or diol, a short-chain aliphatic diacid or diol, and a functionalized comonomer. The monomers are as previously described.

In one or more embodiments, the long-chain aliphatic diacid, diester, or diol, the short-chain aliphatic diacid or diol, and the functionalized comonomer are polymerized via melt polycondensation. In melt polycondensation, monomers are melted and then chemically condensed to provide fairly pure, high molecular weight polymers. As such, the conditions of a given melt polycondensation may depend on the specific monomers involved. For example, the melt polycondensation in accordance with the present disclosure may be carried out at a temperature sufficient to melt the long-chain aliphatic diacid, diester, or diol, the short-chain aliphatic diacid or diol, and the functionalized monomer. Thus, in one or more embodiments, the melt polycondensation may be performed at a temperature ranging from 160 to 270° C. For example, in one or more embodiments, the melt polycondensation may be performed at a temperature ranging from a lower limit of one of 160, 170, 180, 190, and 200° C. to an upper limit of one of 220, 230, 240, 250, 260, and 270° C., where any lower limit may be paired with any mathematically compatible upper limit.

In one or more embodiments, prior to the polymerization, a long-chain aliphatic diacid may be converted (as a pre-step reaction) into a long-chain aliphatic diester, such as by a conventional fischer esterification reaction, and such diester may be reacted with a short-chain aliphatic diol, and the functionalized comonomer.

The polymerization may include stirring the mixture of the recurring units derived from long-chain aliphatic diacid or diol, the short-chain aliphatic diacid or diol, and the functionalized comonomer for a sufficient amount of time. In one or more embodiments, the reaction may be stirred at a speed ranging from 300 to 500 rpm for an amount of time ranging from 2 to 12 hours.

In one or more embodiments, polymerization of the long-chain aliphatic diacid, diester, or diol, the short-chain aliphatic diacid or diol, and the functionalized comonomer may include a catalyst. A catalyst may be included in the polymerization to facilitate the condensation of the monomers. Suitable catalysts that may be included in the polymerization include, but are not limited to, tetrabutyl orthotitanate, dibutyltin dilaurate, dibutyltin oxide, tin(II) 2-ethylhexanoate (stannous octoate), diarylborinic acids, tetrabutyl titanate(IV), titanium(IV) isopropoxide, dibutyltin(IV) oxide, butyltin(IV) tris(octoate), and antimony (III) oxide.

A catalyst may be included in a polymerization in an amount ranging from 0.10 to 0.50 mol %, based on the total moles of the long-chain aliphatic diacid or diol. For example, in one or more embodiments, methods may include a catalyst in an amount ranging from a lower limit of one of 0.10, 0.15, 0.20 0.25, and 0.30 mol % to an upper limit of one of 0.30, 0.35, 0.40, 0.45, and 0.50 mol %, where any lower limit may be paired with any mathematically compatible upper limit.

Polyester compositions prepared according to the above method may be characterized using any suitable analytical technique known in the art. For example, analytical techniques that may be used to characterize polyester compositions include Fourier-transform infrared spectroscopy (FT-IR), acid number, ¹H nuclear magnetic resonance (NMR), ¹³C NMR, wide angle x-ray diffraction (WAXD), atomic force microscopy (AFM), scanning electron microscopy (MEV), rheology measurements, contact angle, stress/strain measurements, thermal gradient interaction chromatography (TGIC), melt flow index (MFI), impact resistance, heat deflection temperature (HDT), DMA, GPC, TGA, and ASTM E1252, among others.

Polymer Blends

In yet another aspect, embodiments of the present disclosure relate to polymer blends including at least two polymers. A polymer blend in accordance with the present disclosure may include a first polymer and a second polymer. The first polymer may be a polyester composition as previously described, and the second polymer may be a polyolefin or a second polyester. Alternatively, the first polymer may be a polyester that does not include recurring units derived from a long chain aliphatic diacid or diol.

In one or more embodiments, a polymer blend includes a first polymer. The first polymer may be a first polyester including recurring units derived from a long-chain aliphatic diacid or diol, a short-chain aliphatic diacid or diol, and a functionalized comonomer having two terminal acid, ester, or alcohol groups as previously described.

The first polymer may be present in the polymer blend in an amount ranging from 1 to 99 wt %, based on the total weight of the polymer blend. For example, the first polymer may be included in the polymer blend in an amount ranging from a lower limit of one of 1, 5, 10, 20, 25, and 30 wt/o to an upper limit of one of 70, 80, 90, 95, and 99 wt %, where any lower limit may be paired with any mathematically compatible upper limit.

In one or more embodiments, the second polymer is a polyolefin. The polyolefin may be any polyolefin known in the art, such as, for example, polyethylene or modified polyethylene. Modified polyethylene may include 1 to 20 wt % of recurring units derived from a comonomer. In some embodiments, the comonomer is grafted on a polyethylene in a post-polymerization reaction. In other embodiments, the comonomer is dispersed randomly throughout the polyethylene. Suitable comonomers include itaconic acid, and carbon monoxide, among others. Thus, examples of modified polyethylene include copolymers including recurring units derived from ethylene and carbon monoxide (CO), grafted copolymers of polyethylene and itaconic acid, among others. Copolymers that include recurring units derived from ethylene and CO may include from 1.0 to 20 wt % CO. The CO monomer in such copolymers may be distributed randomly. Grafted copolymers of polyethylene and itaconic acid may include from 1.0 to 20 wt % itaconic acid. In such grafted copolymers, the itaconic acid may be grafted on polyethene in a post-polymerization reaction, such as, for example, reactive extrusion.

Alternatively, in one or more embodiments, the second polymer is a second polyester. The second polyester may include recurring units derived from a long-chain aliphatic diacid or diol and recurring units derived from a short-chain aliphatic diacid or diol. The long-chain aliphatic diacid or diol and the short-chain aliphatic diacid or diol are as previously described. The long-chain and short chain aliphatic diacids or diols may or may not be the same in the first and second polyesters. In some embodiments, the second polyester includes recurring units derived from a functionalized comonomer as previously described. In other embodiments, the second polyester does not include recurring units derived from a functionalized comonomer.

The second polymer may be present in the polymer blend in an amount ranging from 1 to 99 wt %, based on the total weight of the polymer blend. For example, the second polymer may be included in the polymer blend in an amount ranging from a lower limit of one of 1, 5, 10, 20, 25, and 30 wt % to an upper limit of one of 70, 80, 90, 95, and 99 wt %, where any lower limit may be paired with any mathematically compatible upper limit.

Polymer blends of one or more embodiments may exhibit similar properties as the disclosed polyester composition. Accordingly, polymer blends disclosed herein may have improved barrier properties and adhesion as described above, as well as comparable mechanical and thermal properties as compared to polyethylene or polyethylene blends.

In one or more embodiments, the polymer blend has a tensile modulus, at a 1% secant, ranging from 120 to 800 MPa, as measured according to ASTM D638 Specimen Type IV. For example, polymer blends in accordance with the present disclosure may have a tensile modulus ranging from a lower limit of one of 120, 140, 180, 200, 250, and 300 MPa to an upper limit of one of 400, 500, 600, 700, and 800 MPa, where any lower limit may be paired with any mathematically compatible upper limit.

In one or more embodiments, the polymer blend has a tensile elongation at break ranging from 100 to 1500%, as measured according to ASTM D638 Specimen Type IV. For example, polymer blends in accordance with the present disclosure may have a tensile elongation at break ranging from a lower limit of one of 100, 200, 300, 400, and 500% to an upper limit of one of 1000, 1100, 1200, 1300, 1400, and 1500%, where any lower limit may be paired with any mathematically compatible upper limit.

In one or more embodiments, the polymer blend has a tensile strength at break ranging from 15-100 MPa, as measured according to ASTM D638 Specimen Type IV. For example, polymer blends in accordance with the present disclosure may have a tensile strength at break ranging from a lower limit of one of 15, 20, 25, 30, 35, 40, and 45 MPa to an upper limit of one of 70, 75, 80, 85, 90, 95, and 100 MPa, where any lower limit may be paired with any mathematically compatible upper limit.

In one or more embodiments, polymer blends in accordance with the present disclosure exhibit increase adhesion compared to polyethylene, measured according to ASTM F88.

In one or more embodiments, polymer blends may be included in articles. Suitable articles that may include a polymer blend disclosed herein include films, fibers, filaments, blow-molded articles, 3D printed articles, and injection-molded articles. Such articles may be prepared using polymer blends of one or more embodiments according to methods known in the art.

Articles prepared from polymer blends in accordance with the present disclosure may exhibit improved barrier properties compared to articles prepared from conventional polyethylene.

In one or more embodiments, articles prepared from polymer blends herein have an oxygen (02) transmission rate ranging from 0.01 to 100 cc·mil/in²·day·atm, measured according to ASTM F1927. For example, films or blow-molded articles prepared from the polymer blend of one or more embodiments may have an 02 transmission rate ranging from a lower limit of one of 0.01, 0.05, 0.1, 0.2, 0.5, and 1.0 cc·mil/in²·day·atm to an upper limit of one of 50, 60, 70, 80, 90, and 100 cc·mil/in²·day·atm, where any lower limit may be paired with any mathematically compatible upper limit.

In one or more embodiments, articles prepared from polymer blends herein have a carbon dioxide (CO₂) transmission rate ranging from 0.01 to 100 cc·mil/in²·day·atm, measured according to ASTM F2476. For example, films or blow-molded articles prepared from the polymer blend of one or more embodiments may have a CO₂ transmission rate ranging from a lower limit of one of 0.01, 0.05, 0.1, 0.2, 0.5, and 1.0 cc·mil/in²·day·atm to an upper limit of one of 50, 60, 70, 80, 90, and 100 cc·mil/in²·day·atm, where any lower limit may be paired with any mathematically compatible upper limit.

### EXAMPLES

The synthesis of Examples 1, 2, 3, polyester compositions in accordance with the present disclosure, is described below.

To a 250 ml four-necked glass reaction vessel provided with a propeller stirrer, a nitrogen connection and a water condenser connected to a distillate collection test tube, varying amounts of 2,5-FDCA, octadecanoic acid and 1,4-butanediol were added. The proportions of the monomers in each of Examples 1, 2, and 3 are shown in the Table 1. Then, 0.1 mol % (with respect to the long-chain aliphatic diacid) of tetrabutyl orthotitanate catalyst was added to the reaction vessel.

The reaction vessel was immersed in an oil bath with a thermostat, and heated to a temperature of 220° C. The reaction was then stirred at 400 rpm for 3.5 hours. Water was distilled off during the reaction. After the amount of water collected was greater than 95% of the theoretical amount of water calculated, the nitrogen flux ceased and the pressure was reduced to 0.2 mbar over a period of 1 hour at 230° C. After this period, the temperature was increased to 240° C. and maintained for 3 hours. The polymers produced in each of Examples 1, 2, and 3 were a light brown semi-crystalline solid. The polyester structures were confirmed by Fourier-transform IR spectroscopy.

Along with the proportion of monomers in each Example polyester, Table 1 shows the following thermal properties: melt temperature (Tm), melting heat (ΔHf) and crystallization temperature (Tc), measured using a Perkin Elmer DSC differential scanning calorimeter.

TABLE 1
Compositions and Thermal Properties of Example Polyesters 1, 2, and 3

| | | Octadecanoic | | Tm | ΔHf | Tc |
|---|---|---|---|---|---|---|
| Example | 2,5-FDCA | acid | 1,4-butanediol | (° C.) | (J/g) | (° C.) |
| 1 | 0 | 50 equiv. | 50 equiv. | 87.78 | 90.47 | 46.71 |
| 2 | 5 | 95 equiv. | 100 equiv. | 85.07 | 75.10 | 48.00 |
| 3 | 20 | 80 equiv. | 100 equiv. | 69.64 | 48.61 | 44.35 |

The addition of 2,5-FDCA in increased amounts resulted in a decreased melt temperature and melting heat of the polyester, as shown by the thermal properties of Examples 1, 2, and 3.

For Examples 4-8, the Examples utilize long-chain diacids that are converted to long-chain diesters by conventional Fischer esterification reactions prior to the reaction of the components described below. Resulting formulations and polymer properties are shown in Table 2.

### Example 4—Synthesis of poly(butyl hexadecanoate-co-2,5-furanoate) Containing 1.8% w/w of Dimethyl Ester of 2,5-Furanedicarboxylic Acid as Functionalized Comonomer

The following components were added to a 250 mL four-necked round bottom flask fitted with a mechanical stirrer: 0.16 g (0.89 mmol) of dimethyl ester of 2,5-furandicarboxylic acid, 5.8 g (17 mmol) of 1,18-dimethyl octadecanedioate and 3.2 g (35 mmol) of 1,4-butanediol. The reaction mixture was heated at 115° C. for 15 minutes. After melting, the catalyst Ti(OiPr)₄ (0.191 g, 0.67 mmol) in 2.2 g of toluene was added into the flask under a continuous argon gas flow. The mixture was first stirred for 17 h at 160° C. and then to 215° C. for 2 h, to complete the first stage of pre-polymerization reaction. Finally, a vacuum was gradually applied to reach high molecular weight and the mixture was heated at 215° C. for 4.5 h. After completion of the reaction, the reaction mixture was cooled to room temperature. The polymer was dissolved in a DCM/TFA mixture and precipitated in methanol. After filtration, the powder was dried under a vacuum. A white solid was obtained (6 g, 93% yield).

### Example 5—Synthesis of poly(butyl hexadecanoate-co-2,5-furanoate) Containing 3.9% w/w of Dimethyl Ester of 2,5-Furanedicarboxylic Acid as Functionalized Comonomer

The procedure of Example 4 was repeated using 0.30 g (1.6 mmol) of dimethyl ester of 2,5-furanedicarboxylic acid, 4.5 g (13.2 mmol) of 1,18-dimethyl octadecanedioate, 2.88 g (7.68 mmol) of 1,4-butanediol and 0.213 g (0.75 mmol) of catalyst Ti(OiPr)₄. A white solid was obtained (5 g, 89% yield).

### Example 6—Synthesis of poly(butyl hexadecanoate-co-2,5-furanoate) Containing 7.8% w/w of Dimethyl Ester of 2,5-Furanedicarboxylic Acid as Functionalized Comonomer

The procedure of Example 4 was repeated using 0.70 g (3.8 mmol) of dimethyl ester of 2,5-furanedicarboxylic acid, 4.77 g (13.9 mmol) of 1,18-dimethyl octadecanedioate, 3.42 g (8.89 mmol) of 1,4-butanediol and 0.213 g (0.78 mmol) of catalyst Ti(OiPr)₄. A white solid was obtained (5.7 g, 91% yield).

### Example 7—Synthesis of poly(hexane hexadecanoate-co-itaconate) Containing 3% w/w of Itaconic Acid as Functionalized Comonomer

The procedure of Example 4 was repeated using 0.51 g (3.9 mmol) of itaconic acid, 12 g (35.1 mmol) of 1,18-dimethyl octadecanedioate, 4.6 g (38.7 mmol) of 1,6-hexanediol and 922 μL of a 50% w/w Ti(OiPr)₄ catalyst solution in toluene. A beige solid was obtained (13 g, 76% yield).

### Example 8—Synthesis of poly(butyl hexadecanoate-co-isosorbate) Containing 3.3% w/w of Isosorbide as Functionalized Comonomer

The procedure of Example 4 was repeated using 0.51 g (3.5 mmol) of isosorbide, 12 g (35.1 mmol) of 1,18-dimethyl octadecanedioate, 2.84 g (26.7 mmol) of 1,4 butanediol and 830 μL of a 50% w/w Ti(OiPr)₄ catalyst solution in toluene. A white solid was obtained (12.7 g, 83% yield).

TABLE 2
Polyester formulations derived from Examples 4-8 and their
corresponding properties.

| | Long Chain | Short | Functional | | | | OTR |
|---|---|---|---|---|---|---|---|
| | Diacid/diester- | Chain Diol | Comonomer | Mn | Mw | Tm | (cc/100 |
| Ex | % wt | (% wt) | (wt %) | (g/mol) | (g/mol) | (° C.) | in²/day) |
| 1 | 1,18-dimethyl | 1,4- | 2,5-DMEDCA | 20.100 | 53.600 | 87.8 | 1.12 |
| | octadecanedioate | butanediol | (1.8) | | | | |
| | (63.3) | (34.9) | | | | | |
| 2 | 1,18-dimethyl | 1,4- | 2,5-DMEDCA | 28.100 | 53.600 | 85 | 0.67 |
| | octadecanedioate | butanediol | (3.9) | | | | |
| | (58.6) | (37.5) | | | | | |
| 3 | 1,18-dimethyl | 1,4- | 2,5-DMEDCA | 21.600 | 61.500 | 79.9 | 0.55 |
| | octadecanedioate | butanediol | (7.8) | | | | |
| | (53.7) | (38.5) | | | | | |
| 4 | 1,18-dimethyl | 1,6- | Itaconic acid | 1.111 | 10.605 | 79.6 | ND |
| | octadecanedioate | hexanediol | (3.0) | | | | |
| | (70.1) | (26.9) | | | | | |
| 5 | 1,18-dimethyl | 1,4- | Isosorbide | 2.322 | 12.551 | 74 | ND |
| | octadecanedioate | butanediol | (3.3) | | | | |
| | (78.2) | (18.5) | | | | | |

TABLE 3
Comparative examples of OTR measured in conventional
polymers retrieved from the searchable database
of material properties (MatWeb)

| Polymer | OTR (cc/100 in²/day) |
|---|---|
| HDPE | 1.44 |
| LDPE | 5.80 |
| LLDPE | 2.73 |
| PET | 0.35 |
| PLA | 0.52 |

Embodiments of the present disclosure may provide at least one of the following advantages. The disclosed polyester compositions and polymer blends may be used in applications where polyethylene (e.g., HDPE, LDPE, LLDPE, other ethylene copolymers and polyethylene blends) are generally used. In such applications, the presently described polyester compositions and polymer blends may provide enhanced barrier properties against O₂ and CO₂ in films and blow-molded artifacts when compared to those made with polyethylene. The polyester compositions and polymer blends may also be used in applications where adhesion properties are required, and they present improved behavior when compared to PE. Additionally, in applications where a surface will be printed, the disclosed polyester compositions and polymer blends may eliminate the need of surface treatment (corona, plasma, etc.) or at least decrease the treatment intensity. Finally, the polyester compositions of one or more embodiments may be used in applications where PE does not achieve the requirements, like the typical polyester applications.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A polyester composition comprising:
10 to 90 wt % of recurring units derived from a long-chain aliphatic diacid or diol;
10 to 90 wt % of recurring units derived from a short-chain aliphatic diacid or diol; and
0.1 to 50 wt % of recurring units derived from a functionalized comonomer having two terminal acid, ester, or alcohol groups.

2. The polyester of claim 1, wherein the functionalized comonomer comprises one or more of an aromatic diacid, an aromatic diester, a hydroxyacid, a heterocyclic diol, an unsaturated aliphatic diacid, or an unsaturated aliphatic diol, and combinations thereof.

3. The polyester of claim 1, wherein the functionalized comonomer is biobased.

4. The polyester of claim 1, wherein the long-chain aliphatic diacid or diol comprises 14 to 18 carbon atoms.

5. The polyester of claim 1, wherein the long-chain aliphatic diacid or diol is selected from the group consisting of 1,18-octadecanedioic acid, 1,16-hexadecanoic acid, 1,14-tetradecanedioic acid, 1,18-octadecanediol, 1,16-hexadecanediol, 10,11-dioctylicosanedioic acid, and dimer linoleic diol.

6. The polyester of claim 1, wherein the long-chain aliphatic diacid or diol is biobased.

7. The polyester of claim 1, wherein the long-chain aliphatic diacid is converted to its corresponding diester prior to formation of the polyester.

8. The polyester of claim 1, wherein the short-chain aliphatic diacid or diol is selected from the group consisting of succinic acid, malonic acid, adipic acid, pimelic acid, suberic acid, oxalic acid, itaconic acid, undecanedioic acid, nonanedioic acid, 1,3-propanediol, 1,4-butanediol, 1,5-pentanediol, and 1,6-hexanediol.

9. The polyester of claim 1, wherein the short-chain aliphatic diacid or diol is biobased.

10. The polyester of claim 1, wherein the functionalized comonomer is selected from the group consisting of 2,5-furandicarboxylic acid, 2,4-furandicarboxylic acid, methyl furan-2,5-dicarboxylate, methyl furan-2,4-dicarboxylate, 3-hydroxypropionic acid, glycolic acid, muconic acid, methyl vinyl glycolate, isosorbide, isoidide, isomannide, oxalic acid, and itaconic acid.

11. The polyester of claim 1, wherein the polyester comprises the functionalized comonomer in an amount ranging from 0.1 to 10 wt %.

12. The polyester of claim 1, wherein the polyester is a semi-crystalline polymer having a crystallinity of up to 70%.

13. The polyester of claim 1, wherein the polyester is an amorphous polymer.

14. The polyester of claim 1, wherein the polyester has a number average molecular weight ranging from 500 to 1,000,000 g/mol.

15. The polyester of claim 1, wherein the polyester has a melt temperature, as determined by ASTM D3418, ranging from 60 to 150° C.

16. The polyester of claim 1, wherein the polyester has a melt temperature, as determined by ASTM D3418, ranging from 80 to 120° C.

17. The polyester of claim 1, wherein the polyester has a tensile modulus at 1% secant, as determined by ASTM D638 Specimen Type IV, ranging from 120 to 800 MPa.

18. The polyester of claim 1, wherein the polyester has a tensile elongation at break, as determined by ASTM D638 Specimen Type IV, ranging from 100 to 150%.

19. The polyester of claim 1, wherein the polyester has a tensile strength at break, as determined by ASTM D638 Specimen Type IV, ranging from 15 to 100 MPa.

20. A method of producing the polyester of claim 1, the method comprising:
polymerizing a long-chain aliphatic diacid, diester, or diol, a short-chain aliphatic diacid or diol, and a functionalized co-monomer by melt polycondensation to form the polyester of claim 1.

21. The method of claim 20, wherein the melt polycondensation is performed at a temperature ranging from 160 to 270° C.

22. The method of claim 20, wherein the melt polycondensation is performed with a catalyst selected from the group consisting of tetrabutyl orthotitanate, dibutyltin dilaurate, dibutyltin oxide, tin(II) 2-ethylhexanoate (stannous octoate), diarylborinic acids, tetrabutyl titanate(IV), titanium(IV) isopropoxide, dibutyltin(IV) oxide, butyltin(IV) tris(octoate), and antimony (III) oxide.

23. The method of claim 22, wherein the catalyst is included in the melt polycondensation in an amount ranging from 0.1 to 0.5 mol %, based on the moles of the long-chain monomer.

24. An article comprising the biobased polyester of claim 1.

25. The article of claim 24, wherein the article is selected from the group consisting of films, fibers, filaments, blow-molded articles, and injection-molded articles.

26. The article of claim 24, wherein the article has an O₂ transmission rate ranging from 100 to 0.1 cc·mil/in²·day·atm, as determined by ASTM F1927.

27. The article of claim 24, wherein the article has a CO₂ transmission rate ranging from 100 to 0.1 cc·mil/in²·day·atm, as determined by ASTM F2476.

28. A blended polymer composition comprising:
a first polymer; and
a second polymer, wherein at least one of the first polymer and the second polymer comprises the polyester composition of claim 1.

29. The blended polymer of claim 28, wherein the first polymer is present in an amount ranging from 1 to 99%, based on the total weight of the blended polymer.

30. The blended polymer of claim 28, wherein the second polymer is present in an amount ranging from 1 to 99%, based on the total weight of the blended polymer.

31. The blended polymer of claim 28, wherein the first polymer comprises the polyester composition of any of claims 1-18.

32. The blended polymer of claim 28, wherein the second polymer is a polyester comprising:
10 to 90 wt % of recurring units derived from a long-chain aliphatic diacid or diol; and
10 to 90 wt % of a recurring units derived from a short-chain aliphatic diacid or diol.

33. The blended polymer of claim 28, wherein the second polymer is a polyolefin.

34. 33. The blended polymer of claim 28, further comprising a third polymer.

35. The blended polymer of claim 28, wherein the blended polymer has a melt temperature, as determined by ASTM D3418, ranging from 60 to 150° C.

36. The blended polymer of claim 28, wherein the blended polymer has a melt temperature, as determined by ASTM D3418, ranging from 80 to 120° C.

37. The blended polymer of claim 28, wherein the blended polymer has a tensile modulus (1% secant), as determined by ASTM D638 Specimen Type IV, ranging from 120 to 800 MPa.

38. The blended polymer of claim 28, wherein the blended polymer has a tensile elongation at break, as determined by ASTM D638 Specimen Type IV, ranging from 100 to 150%.

39. The blended polymer of claim 28, wherein the blended polymer has a tensile strength at break, as determined by ASTM D638 Specimen Type IV, ranging from 15 to 100 MPa.

40. The blended polymer of claim 28, wherein the first polymer is a polyester that does not comprise a long-chain aliphatic diacid or diol.

41. The blended polymer of claim 40, wherein the second polymer is a modified polyethylene.

42. The blended polymer of claim 41, wherein the modified polyethylene comprises 1 to 20 wt % carbon monoxide.

43. The blended polymer of claim 41, wherein the modified polyethylene comprises 1 to 20 wt % itaconic acid.

44. A method of producing the blended polymer of claim 28, comprising:
combining the first polymer and the second polymer to form a mixture; and
extruding the mixture to form the blended polymer of claim 28.

45. The method of claim 44, wherein combining the first polymer and the second polymer comprises mixing the first polymer and the second polymer in a heater chamber.
